(19) United States
(12) Patent Application Publication
(10) Pub. No.: US 2014/0358501 A1
(43) Pub. Date: Dec. 4, 2014

(54) METHOD AND SYSTEM FOR MODELING CURRENT TRANSMISSION ON PRINTED CIRCUIT BOARD

(71) Applicants: HON HAI PRECISION INDUSTRY CO., LTD., New Taipei (TW); HONG FU JIN PRECISION INDUSTRY (SHENZHEN) CO., LTD., Shenzhen (CN)

(72) Inventors: JENG-DA WU, New Taipei (TW); GUANG-FENG OU, Shenzhen (CN); YANG-BO PENG, Shenzhen (CN)

(73) Assignees: HON HAI PRECISION INDUSTRY CO., LTD., New Taipei (CN); HONG FU JIN PRECISION INDUSTRY (SHENZHEN) CO., LTD., Shenzhen (CN)

(21) Appl. No.: 14/137,251

(22) Filed: Dec. 20, 2013

(30) Foreign Application Priority Data
Jun. 3, 2013 (CN) 2013102146893

(51) Int. Cl. G06F 17/50

(52) U.S. Cl. CPC G06F 17/5009
USPC 703/2

(57) ABSTRACT

A system for modeling current transmission on a printed circuit board (PCB), the system includes a layout information obtaining module, a power setting module, a calculating module and an analyzing module. The layout information obtaining module obtains layout information of the PCB. The power setting module sets output voltages of multiple voltage regulating modules and a variation range of the output voltages. The calculating module builds a current transmission model script of the PCB according to the settings, executes the current transmission model script, and calculates working voltages of the multiple receiving terminals. The analyzing module compares the working voltages of the multiple receiving terminals with voltages of the variation range of the output voltages, and determines whether the layout information of the PCB complies with the design specification.

### BACKGROUND

1. Technical Field

The present disclosure relates to a method and system for modeling current transmission on a printed circuit board.

2. Description of Related Art

A printed circuit board (PCB) often has multiple integrated chips (ICs). Large number of power supply traces connecting electronic components, such as capacitors, resistors, and copper coils to the integrated chips. Each of the integrated chips is powered by a normal direct current. When the integrated chips are not able to function normally, the number of the electronic components need to be adjusted accordingly. The design of the layout of the PCB is required to comply with predetermined rules. However, existing testing technologies depends very much on human experiences and judgments, which may not be accuracy or efficient.

Therefore, there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a system for modeling current transmission on a printed circuit board (PCB).

FIG. 2 is a block diagram of an embodiment of the current transmission modeling unit of FIG. 1.

FIG. 3 is a flow chart of an embodiment of a method for modeling current transmission on the PCB.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blue-Ray discs, Flash memory, and hard disk drives.

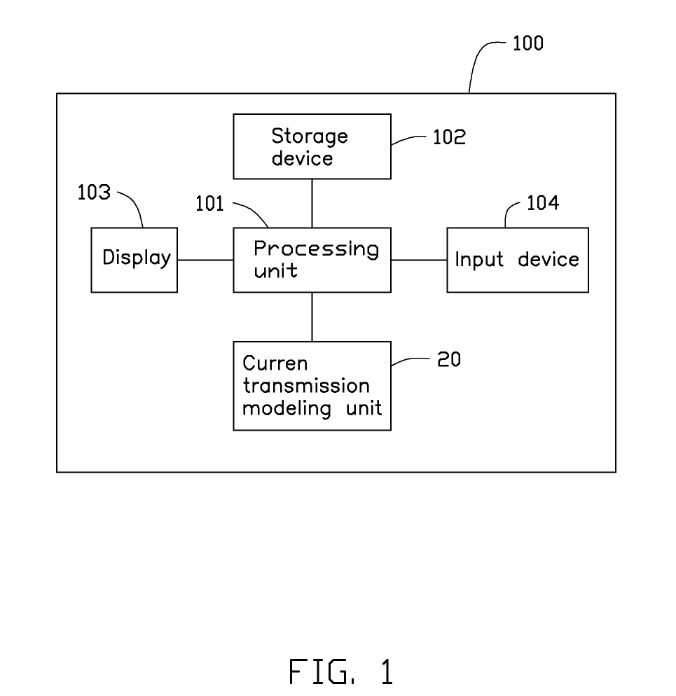

FIG. 1 shows a system 100 for modeling current transmission on a printed circuit board (PCB) in accordance with one embodiment. The system 100 includes a processing unit 101, a storage device 102, a display 103, an input device 104 and a current transmission modeling unit 20. The system 100 may be a host computer, a server computer, a table computer, or the like.

The processing unit 101 is coupled to the storage device 102, the display 103, the input device 104, and the current transmission modeling unit 20. The processing unit 101 may include one or more processors that provide the processing capability to execute the operating system, programs, user and application interfaces. The current transmission modeling unit 20 is executable by the processing unit 101, and is configured for modeling current transmission on the PCB.

The storage device 102 may store a variety of information and may be used for various purposes. For example, the storage device 102 may store various programs, applications, user interface functions, and processor functions, for example.

The display 103 may provide a visual output interface between the system 100 and a user. The visual output may include text, graphics, video, and any combination thereof. The display 103 may use LCD (liquid crystal display) technology, or LPD (light emitting polymer display) technology, although other display technologies may be used in other embodiments.

The input device 104 may provide an input interface between the system 100 and a user. The input device 104 may be a keyboard, a mouse or a touch pad, which can be used to input information.

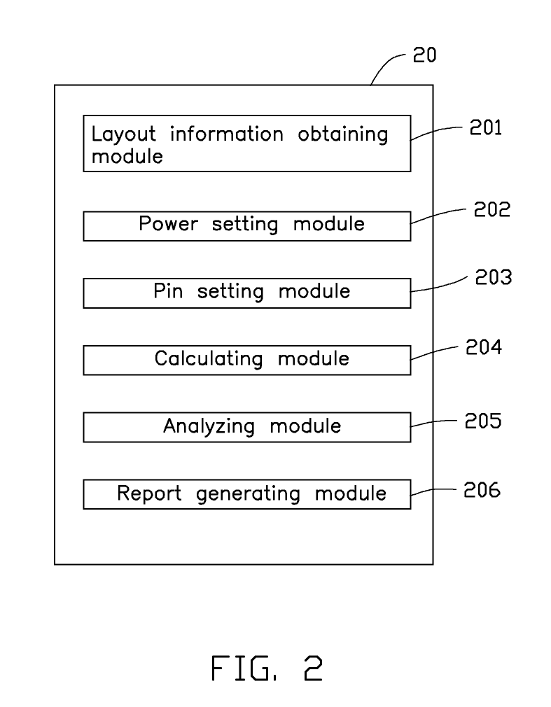

FIG. 2 shows a block diagram of an embodiment of the current transmission modeling unit 20. The current transmission modeling unit 20 includes a layout information obtaining module 201, a power setting module 202, a pin setting module 203, a calculating module 204, an analyzing module 205 and a report generating module 206.

The layout information obtaining module 201 is configured for obtaining layout information of the PCB. The layout information includes component names, trace names, and copper coil widths.

The power setting module 202 is configured for setting parameters including output voltages of multiple voltage regulating modules (VRMs), a variation range of the output voltages of the multiple VRMs, maximum currents of multiple branch circuits, input voltages of multiple receiving terminals, a variation range of the input voltages of the multiple receiving terminals and parameters of passive devices on the multiple branch circuits. The passive device may be a capacitor, a resistor, an inductor or a fuse.

The pin setting module 203 is configured for setting parameters including positive and negative pins of the output voltages of the multiple VRMs and positive and negative pins of the input voltages of the multiple receiving terminals.

The calculating module 204 is configured for building a current transmission model script of the PCB according to the parameters set by the power setting module and the pin setting module, executing the current transmission model script, and calculating working voltages of the multiple receiving terminals.

The analyzing module 205 is configured for comparing the working voltages of the multiple receiving terminals with voltages of the variation range of the output voltages of the multiple VRMs, and determining whether the layout information of the PCB complies with a design specification. If the working voltages of the multiple receiving terminals are within a range of the variation range of the output voltages of the multiple VRMs, the layout information of the PCB complies with the design specification. If the working voltages of the multiple receiving terminals are not within a range of the variation range of the output voltages of the multiple VRMs, the layout information of the PCB does not comply with the design specification.

The report generating module 206 is configured for generating a current transmission modeling report depicting whether the layout information of the PCB complies with the design specification.

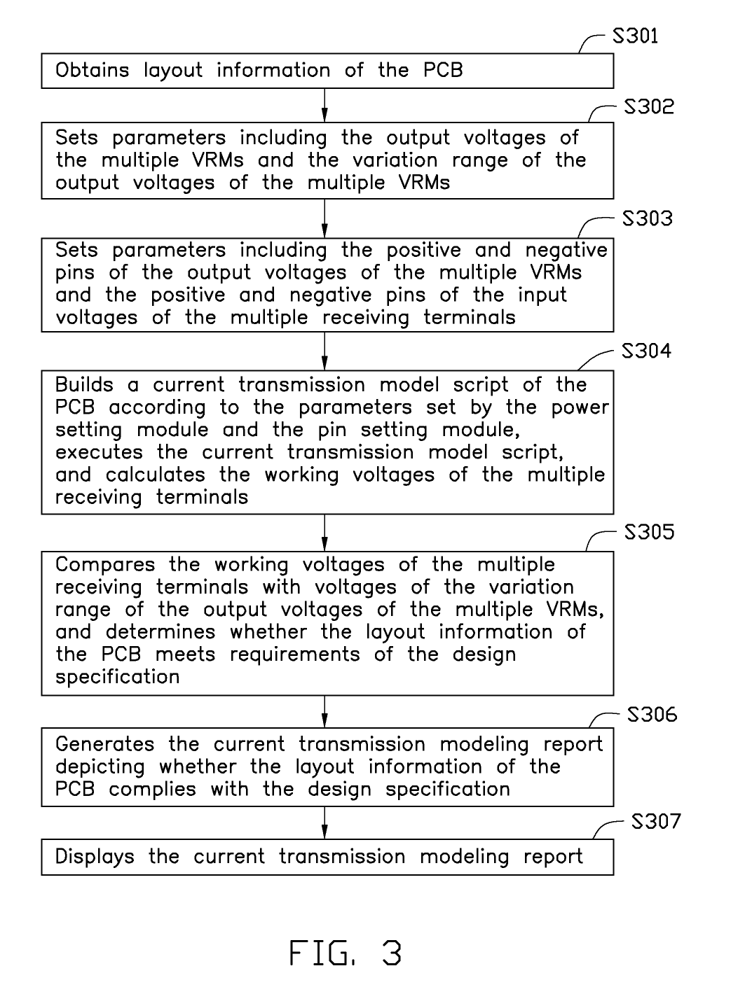

FIG. 3 shows a flow chart of a method for modeling current transmission on the PCB in accordance with one embodiment. Depending on the embodiment, certain steps described below may be removed, while others may be added, and the sequence of the steps may be altered. In one embodiment, the method for testing working voltage of a CPU utilizing the above-described system includes the following steps:

S301: the layout information obtaining module 201 obtains layout information of the PCB;

S302: the power setting module 202 sets parameters including the output voltages of the multiple VRMs, the variation range of the output voltages of the multiple VRMs, the maximum currents of the multiple branch circuits, the input voltages of the multiple receiving terminals, the variation range of the input voltages of the multiple receiving terminals and parameters of passive devices on the multiple branch circuits;

S303: the pin setting module 203 sets parameters including the positive and negative pins of the output voltages of the multiple VRMs and the positive and negative pins of the input voltages of the multiple receiving terminals;

S304: the calculating module 204 builds a current transmission model script of the PCB according to the parameters set by the power setting module and the pin setting module, executes the current transmission model script, and calculates the working voltages of the multiple receiving terminals;

S305: the analyzing module 205 compares the working voltages of the multiple receiving terminals with voltages of the variation range of the output voltages of the multiple VRMs, and determines whether the layout information of the PCB meets requirements of the design specification;

S306: the report generating module 206 generates the current transmission modeling report depicting whether the layout information of the PCB complies with the design specification;

S307: the display 103 displays the current transmission modeling report.

Even though numerous characteristics and advantages of the present disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. A system for modeling current transmission on a printed circuit board (PCB), the system comprising:
a storage device;
a processing unit coupled to the storage device; and
one or more programs stored in the storage device and executed by the processing unit, the one or more programs comprising:
a layout information obtaining module configured for obtaining layout information of the PCB;
a power setting module configured for setting parameters comprising output voltages of multiple voltage regulating modules (VRMs) and a variation range of the output voltages of the multiple VRMs;
a pin setting module configured for setting parameters comprising positive and negative pins of the output voltages of the multiple VRMs and positive and negative pins of the input voltages of multiple receiving terminals;
a calculating module configured for building a current transmission model script of the PCB according to the parameters set by the power setting module and the pin setting module, executing the current transmission model script, and calculating working voltages of the multiple receiving terminals; and
an analyzing module configured for comparing the working voltages of the multiple receiving terminals with voltages of the variation range of the output voltages of the multiple VRMs, and determining whether the layout information of the PCB complies with a design specification.

2. The system of claim 1, further comprising a report generating module configured for generating a current transmission modeling report depicting whether the layout information of the PCB complies with the design specification.

3. The system of claim 2, further comprising a display configured for displaying the current transmission modeling report.

4. The system of claim 1, wherein if the working voltages of the multiple receiving terminals are within a range of the variation range of the output voltages of the multiple VRMs, the layout information of the PCB complies with the design specification; and if the working voltages of the multiple receiving terminals are not within a range of the variation range of the output voltages of the multiple VRMs, the layout information of the PCB does not comply with the design specification.

5. A method for modeling current transmission on a printed circuit board (PCB), the method comprising:
obtaining layout information of the PCB;
setting first parameters comprising output voltages of multiple voltage regulating modules (VRMs) and a variation range of the output voltages of the multiple VRMs;
setting second parameters comprising positive and negative pins of the output voltages of the multiple VRMs and positive and negative pins of the input voltages of multiple receiving terminals;
building a current transmission model script of the PCB according to the first and the second parameters, executing the current transmission model script, and calculating working voltages of the multiple receiving terminals; and
comparing the working voltages of the multiple receiving terminals with voltages of the variation range of the output voltages of the multiple VRMs, and determining whether the layout information of the PCB complies with a design specification.

6. The method of claim 5, further comprising setting maximum currents of multiple branch circuits, input voltages of the multiple receiving terminals, a variation range of the input voltages of the multiple receiving terminals and parameters of passive devices on the multiple branch circuits.

7. The method of claim 6, wherein the passive device is a capacitor, a resistor, an inductor or a fuse.

8. The method of claim 6, further comprising generating a current transmission modeling report depicting whether the layout information of the PCB complies with the design specification.

9. The method of claim 7, further comprising displaying the current transmission modeling report.

10. The method of claim 6, wherein if the working voltages of the multiple receiving terminals are within a range of the variation range of the output voltages of the multiple VRMs, the layout information of the PCB complies with the design specification; and if the working voltages of the multiple receiving terminals are not within a range of the variation range of the output voltages of the multiple VRMs, the layout information of the PCB does not comply with the design specification.
